(19) United States
(12) Patent Application Publication
(10) Pub. No.: US 2017/0264923 A1
(43) Pub. Date: Sep. 14, 2017

(54) DYNAMIC MANIFEST FOR CONTENT PROGRAMMING

(71) Applicant: thePlatform, LLC, Seattle, WA (US)

(72) Inventors: Jeremy Lacivita, Seattle, WA (US); Daniel Niland, Seattle, WA (US); Curtis Fulton, Vashon, WA (US)

(21) Appl. No.: 15/066,295

(22) Filed: Mar. 10, 2016

(51) Int. Cl. H04N 21/2387; H04N 21/845; H04N 21/4627; H04N 21/472; H04N 21/4147; H04N 21/254; H04L 29/06; G11B 27/10

(52) U.S. Cl. CPC H04N 21/2387; H04L 65/601; H04L 65/4084; H04N 21/8456; G11B 27/10; H04N 21/47202; H04N 21/4147; H04N 21/2541; H04N 21/4627

(57) ABSTRACT

Systems and methods for controlling playback of a content asset are disclosed. In an aspect, one method can comprise receiving a request relating to a content asset. A first dynamic manifest can be generated in response to the request. The first dynamic manifest can relate to a first segment of the content asset. The first segment has a playback duration that is less than the playback duration of the entire content asset. The first dynamic manifest can be transmitted to a source of the request, wherein the first dynamic manifest facilities access to only a portion of the content asset. A request for a second manifest can be received. A second dynamic manifest can be generated in response to at least the request for the second manifest. The second dynamic manifest can be transmitted to a source of the request.

### BACKGROUND

Typically, VOD, Cloud DVR, and other non-linear content are delivered to a media player by first delivering a complete manifest of video fragments to the user device. The media player uses the manifest to request the video fragments from a stored location and displays the video fragments, once received. Since the media player initially receives the complete, the media player also has control over functions such as playback controls, permissions, and advertisement insertion, for example. As a further example, the media player may cause playback without receiving any intervening updates. These and other shortcomings are identified and addressed by the disclosure.

### SUMMARY

The methods and systems of the present disclosure, in one aspect, provide a dynamic manifest for content. Instead of delivering the entire manifest to a media player at the outset of content deliver, a computing device such as a manifest server can deliver a dynamic manifest relating to a specific time duration of playback (e.g., n seconds worth of content fragments) of content.

In an aspect, methods can comprise receiving a request for content. In response to the request for the first manifest, a first dynamic manifest can be generated, for example by a computing device such as a manifest server. The first dynamic manifest can relate to a first segment of a content asset, wherein the first segment has a playback duration that is less than the playback duration of the entire content asset. The first dynamic manifest can be transmitted to a source of the request such as a user device or a media player executing on a user device. The first dynamic manifest can facilitate access to only a portion of the content asset. A request for a second manifest can be received, for example by the computing device receiving the request for the first manifest. One or more rules can be analyzed based at least on the request for the second manifest. As an example, the one or more rules can relate to one or more of a trick play feature, a content permission, and a content insertion. A second dynamic manifest can be generated in response to at least the request for the second manifest and the one or more rules. The second dynamic manifest can relate to a second segment of the content asset. The second dynamic manifest can be transmitted to a source of the request.

In another aspect, methods can comprise transmitting a request relating to a linear content asset. A first dynamic manifest can be received in response to the request relating to a non-linear content asset. The first dynamic manifest can relate to a first segment of the non-linear content asset. The first segment can have a playback duration that is less than the playback duration of the entire non-linear content asset. A request for the first segment of the non-linear content asset can be transmitted based at least on the first dynamic manifest. A request for a second manifest can be transmitted. As an example, the second manifest can relate to a second segment of the non-linear content asset.

In yet another aspect, methods can comprise receiving a request relating to a content asset. A first dynamic manifest can be generated in response to the request relating to a content asset. The first dynamic manifest can relate to a first segment of the content asset. The first segment has a playback duration that is less than the playback duration of the entire content asset. The first dynamic manifest can be transmitted to a source of the request, wherein the first dynamic manifest facilities access to only a portion of the content asset. A request for a second manifest can be received. A second dynamic manifest can be generated in response to at least the request for the second manifest. The second dynamic manifest can be transmitted to a source of the request.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an example system and network;

FIG. 2 is a representation of an example interface;

FIG. 3 is a block diagram of an example system and data flow;

FIG. 4 is a flow chart of an example method;

FIG. 5 is a flow chart of an example method;

FIG. 6 is a flow chart of an example; and

FIG. 7 is a block diagram of an example computing system.

### DETAILED DESCRIPTION

The methods and systems of the present disclosure, in one aspect, provide a dynamic manifest for content (e.g., linear content, non-linear content, etc.). As an example, a computing device such as a manifest server can deliver a dynamic manifest relating to a specific time duration of playback (e.g., n seconds worth of content fragments) of a content asset. When the media player nears the end of the manifest that it has, it can request the next piece of the manifest that relates to the next portion of the content asset.

The use of the dynamic manifest can shift playback state control from the media player to the upstream computing device (e.g., server). Instead of the media player having access to all of the segments of a particular content asset, each dynamic manifest provides information relating to only a portion (e.g., n seconds of playback) of the overall content asset. As such, requests for trick play controls are routed to the server, which ensure policy enforcement by the content provider rather than the media player. As another example, advertisement insertion decisions can be made at the server and can be modified in real-time. As a further example, by moving control in to the server, the server can better know about and adapt to issues in the system and network architecture. If an advertisement server is unavailable, instead of relying on the user device to handle the outage, the server can manage the outage without disrupting playback via the media player.

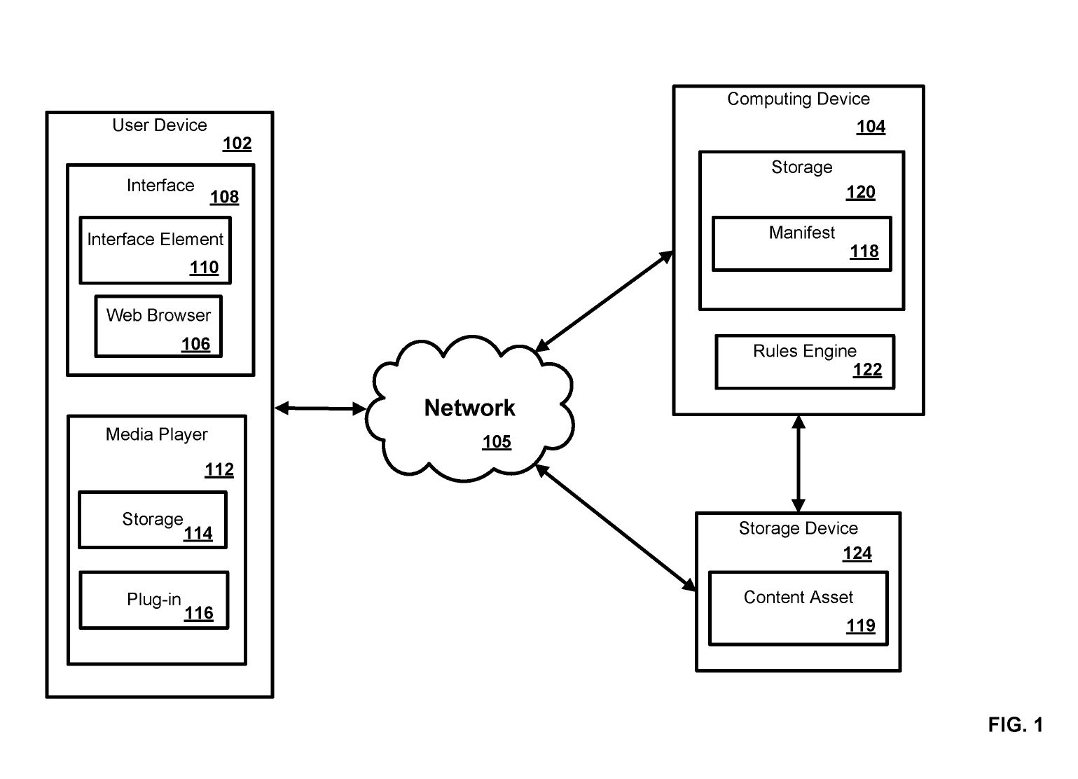

FIG. 1 illustrates various aspects of an exemplary network in which the present methods and systems can operate. The present disclosure relates to an agnostic data engine. Those skilled in the art will appreciate that present methods may be used in systems that employ both digital and analog equipment. One skilled in the art will appreciate that provided herein is a functional description and that the respective functions can be performed by software, hardware, or a combination of software and hardware.

A system 100 and network can comprise a user device 102 in communication with a computing device 104, such as a server, for example. The computing device 104 can be disposed locally or remotely relative to the user device 102. As an example, the user device 102 and the computing device 104 can be in communication via a network 105 such as private or public network (e.g., Internet). Other forms of communications can be used, such as wired and wireless telecommunication channels, for example.

In an aspect, the user device 102 can be an electronic device such as a computer, a smartphone, a laptop, a tablet, a set top box, or other device capable of communicating with the computing device 104. As an example, the user device 102 can comprise a web browser 106 for providing an interface to a user to interact with the user device 102 and/or the computing device 104. The web browser 106 can be any interface for presenting information to the user and receiving a user feedback such as Internet Explorer, Mozilla Firefox, Google Chrome, Safari, or the like. Other software, hardware, and/or interfaces can be used to provide communication between the user and one or more of the user device 102 and the computing device 104. As an example, the web browser 106 can request or query various files from a local source and/or a remote source.

In an aspect, the user device 102 can comprise an interface 108 such as a user interface or API. As an example, the interface 108 can be configured to provide a visual presentation, audio presentation, interactive communication, and the like. As a further example, interface 108 can comprise one or more interface elements 110. In an aspect, the interface elements 110 can comprise a menu, icon, user-selectable button, drop-down, slider bar, input field, and the like. As an example, one or more of the interface elements 110 can be configured to receive a selection or input from a user.

The user device 102 can comprise a media player 112 configured to process information to cause playback of content via the interface 108. In an aspect, the media player 112 may comprise the web browser 106 and/or software to effect playback of content and features relating to such playback. As an example, the media player 112 can be configured to transmit a request, such as a HTTP GET request over network 105 to the computing device 104. The computing device 104 may then forward various parameters received from the request originating from the user device 102 to a rules engine 122. The user device 102 can also explicitly send parameter data to the computing device 104 voluntarily or in response to a request for client parameters. The computing device 104 may then utilize the rules engine 122 to evaluate various business rules and create a dynamic manifest 118 accordingly, which can then be passed back to user device 102 over network 105 and placed into storage 114.

The media player 112 can process the manifest 118 to playback video content via the interface 108. For example, the manifest 118 may reference one or more segments of a content asset 119, for example, in storage 124. Thus, the manifest 118 may comprise a playlist file such as a M3U8 playlist file. The media player 112 may then request, stream, decode, and output the referenced content segments seamlessly to the interface 108 to playback the requested portion of the content asset 119.

In an aspect, one or more software components such as plug-ins 116 can be provided to the user device 102. As an example, plug-ins 116 can comprise an extension or software component that adds specific abilities to another software application. As an example, one or more plug-ins 116 can be configured to customize the functionality of a particular application such as the interface 108.

In an aspect, the computing device 104 can be a network device such as a server (e.g., manifest server) for communicating with the user device 102. As an example, the computing device 104 can communicate with the user device 102 for providing services such as network (e.g., IP) services using one or more protocols (e.g., FTP, HTTP, etc.).

In an aspect, the computing device 104 can manage the communication between the user device 102 and storage 120 for sending and receiving data therebetween. As an example, the storage 120 can store a plurality of data sets, manifests 118, content assets, user identifiers or records, authentication information, or other information. As a further example, the user device 102 can request and/or retrieve a file from the storage 120 such one or more of the manifests 118. The storage 120 can be integrated with the computing system 104 or some other device or system.

As an example, the storage device 124 can be in communication with one or more of the user device 102 and the computing device 104 to send/receive data such as content segments and/or index information relating to one or more content assets 119. As a further example, the storage device 124 can be located remotely from the user device 102, such as a network storage medium, network digital video recorder system, and the like. In an aspect, to manage the content assets 119 accessed via the storage device 124, and/or other devices, a manifest (e.g., manifest 118) can be generated as an index of data stored in one or more locations and/or in one or more storage mediums.

In another aspect, the manifest can comprise the locations of various quality level (bitrate and resolution) content segments located at network storage or local device storage or combination thereof. As an example, a device can receive the manifest 118 and can dynamically request particular data to be received. Transmission of any combination various content segments having varying network/local storage locations can be facilitated on the segment-by-segment basis using a plurality of the manifests 118. For example, the manifests 118 can be updated on a segment-by-segment basis by the computing device 104.).

In an aspect, the manifests 118 can provide location information that can be processed by the user device 102 (e.g., the media player 112 executing via the user device 102) to facilitate locating and/or requesting particular data segments from one or more of a plurality of sources.

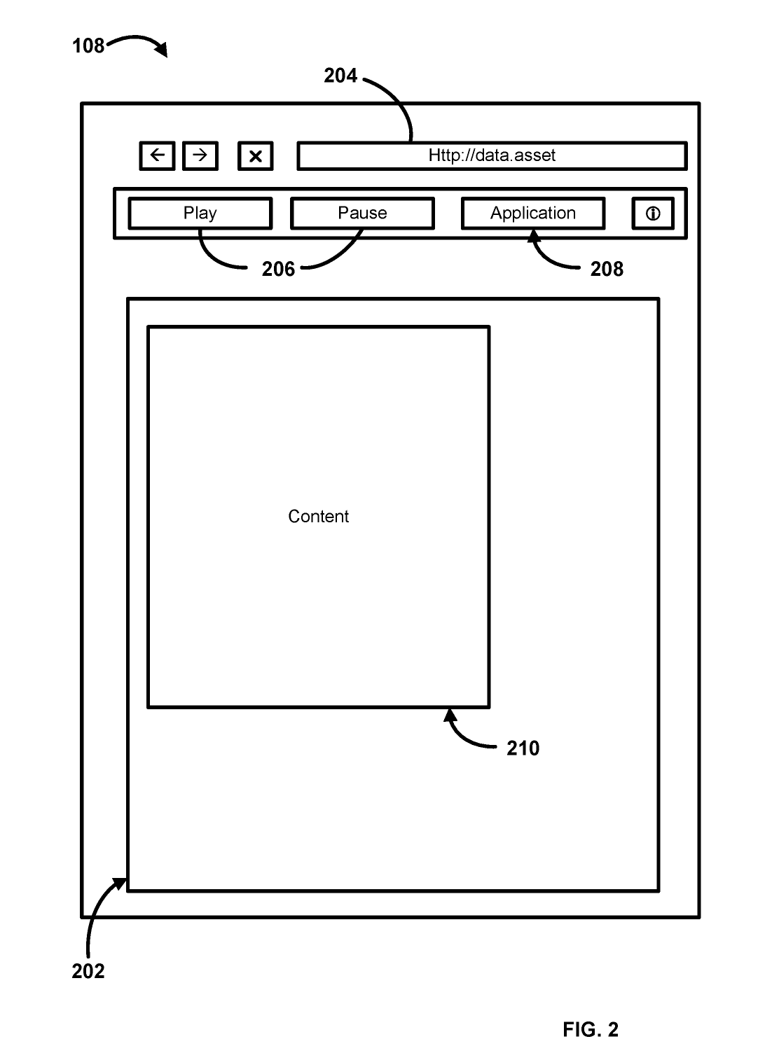

The methods and systems can comprise a software interface such as interface 108, as illustrated in FIG. 2. By way of example, the interface 108 can be loaded to the user device 102 as an add-on software package. The methods and systems disclosed can utilize one or more interfaces 108 to perform one or more functions in one or more locations. FIG. 2 illustrates an exemplary interface 108 for performing the disclosed methods. This exemplary interface 108 is only an example of an interface and is not intended to suggest any limitation as to the scope of use or functionality of interface architecture. Neither should the interface 108 be interpreted as having any dependency or requirement relating to any one or combination of components illustrated in the interface 108.

In an aspect, the interface 108 can comprise a viewing window 202 for displaying information (e.g. web pages, files, etc.) to the user. As an example, the interface 108 can comprise an address bar 204 or URL bar to allow a user to input a URL for directing the requests of the interface 108. In an aspect, the interface 108 can comprise a toolbar disposed adjacent the address bar 204 of the interface 108 and including one or more interface elements, buttons, or engageable menus. The interface 108 can be presented to the user in any position, form, and environment. As an example, the interface 108 can comprise a plurality of interface elements, such as user-engageable buttons 206 for executing various associated functions (e.g. search function, settings modification, play, pause, seek, and the like.)

In an aspect, the interface 108 can comprise an interface element such as home button, preset function, or pointer for directing the interface 108 to a pre-defined file or webpage, and/or a plug-in, extension, or an application 208 requiring a plug-in or extension. In another aspect, the interface 108 can be configured to present data to a user such as via the viewing window 202. As an example, the interface 108 can present content 210 to a user. As a further example, the interface elements can be used to interact with the content 210.

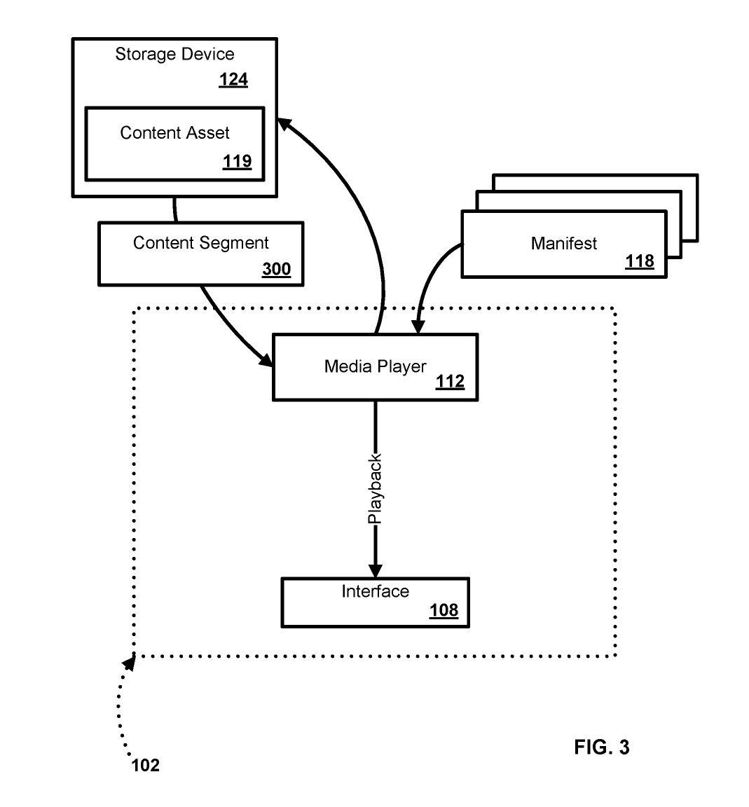

FIG. 3 is a block diagram of an example system. In an aspect, a device such as the user device 102 and/or the media player 112 can be configured to receive a series of the manifests 118. The manifest 118 can comprise identifiers associated with one or more content assets such as videos, segments, data blocks, and the like. In an aspect, the manifest 118 can comprise information relating to one or more segments of the content assets such as location, bitrate, resolution, and the like. When the location of one or more of the data segments is changed, one or more of the manifests 118 can be modified to reflect the updated location of the data segments. As an example, a device, such as computing device 104 (FIG. 1), can be configured to monitor locations of one or more data segments or items can automatically update the manifest 118 to reflect and up-to-date location of the data segments. As a further example, information relating to the location of the data segments can be accessed or received and the manifest 118 can be generated in real-time.

In one aspect, the manifests 118 can comprise an index of data segments such as segments of a content asset. The index can comprise an index value associated with each data segment. The index values can indicate temporal order for playback of the data segments. For example, the index values can be time values according to a time length of playback of the content. The time values can be based on a time scale associated with the content asset. As a further example, the time scale can begin at beginning of the content and end at the end of the content. In another aspect, the index value can comprise a number indicating the place of the data fragment in the sequential order of playback.

In one aspect, the manifests 118 can comprise location identifiers configured to indicate the location where the data segments can be accessed. For example, the location of each data fragment can be indicated by a uniform resource identifier, such as a uniform resource locator (URL). The URL can comprise, for example, a hypertext transfer protocol link or other link.

In one aspect, the manifests 118 can comprise access restrictions associated with the data fragments. For example, manifests 118 can comprise instructions that specific data segments are not to be skipped in playback of the content. In another aspect, the manifests 118 can comprise indications of media format (e.g., MIME types such as video/mp4), type of delivery (e.g., live streaming format with access patterns that accommodate potentially infinite duration, or on-demand format where the content duration is known and finite), digital rights management (DRM) information used for playback, indications for multilingual content (e.g., audio and data fragments associated with specific languages), and the like.

In an aspect, the media player 112 can receive the manifests 118 and can request particular data segments to be received based at least on the received manifest 118. Transmission of any combination of various data segments having varying quality level and network/local storage location can be facilitated on a segment by segment basis based on the manifest 118. As an example, a first one of the manifest 118 can relate to a first content segment 300 of a non-linear content asset (e.g., content asset 119), wherein the first content segment 300 has a playback duration that is less than the playback duration of the entire non-linear content asset. It is understood that linear content assets may used in a similar manner and may be referenced by the manifest 118 as discussed for non-linear assets. If the media player 112 reaches the end of the first one of the manifests 118, the user device can request and receive a second one of the manifests 118 to continue the seamless playback of content such as the next segment of the non-linear content asset or an advertisement, etc.

Each of the manifests 118 can be dynamically generated to customized information to the media player 112 based upon the requests from the media player 112. As subsequent ones of the manifests 118 are received and processed, the media player 112 can request new content such as the content segments 300 and can process the received content to facilitate playback via the interface 108 of the user device. The use of the dynamic manifests 118 can shift playback state control from the media player 112 to the upstream computing device (e.g., server, computing device 104 (FIG. 1)). Instead of the media player 112 having access to all of the segments of a particular content asset, each dynamic manifest 118 provides information relating to only a portion (e.g., n seconds of playback) of the overall content asset.

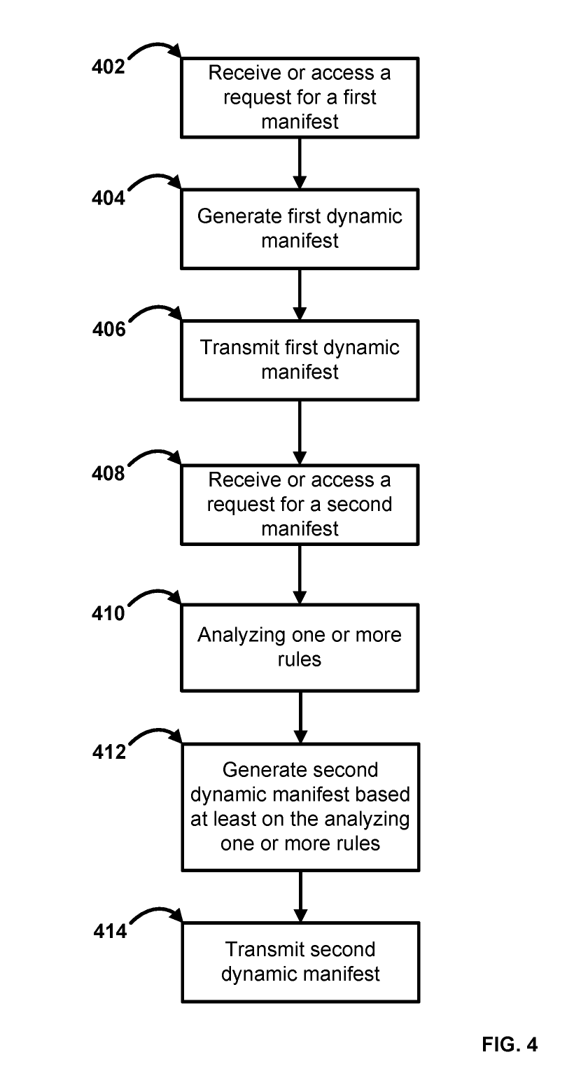

FIG. 4 illustrates an example method for managing playback of content. In step 402, a request for content can be received or accessed by a computing device (e.g., the computing device 104). In an aspect, the request for content can comprise a request for linear content such as tuning to a linear content channel. In another aspect, the request for content can comprise a request for a first manifest, which can be received via a manifest server, for example. The first manifest can comprise information relating to a location of one or more segments of a content asset such as an IP address, identifier of one or more content assets (e.g., advertisements, video on demand assets, recorded asset) browser or operating platform, device identifiers, browser cookies or login details, screen resolution of display, and other device, display, content, or user parameters. As an example, a user device and/or a media player executing on the user device can comprise a web browser (e.g., HLS enabled web browser). A user can use the media player to navigate to a website presenting a list of available content. After the user selects the content for playback, a request for the first manifest, such as a HTTP GET request, may be sent over a network to the computing device.

In step 404, a first dynamic manifest can be generated. In an aspect, the first dynamic manifest can be generated in response to the request for content. The first dynamic manifest can be dynamic in the sense that it can be customized based on the request and/or information relating to a source for the request for the first manifest. The first dynamic manifest can comprise information relating to a location of one or more segments of a content asset such as a non-linear content asset. Segments of linear content assets may also be referenced by the manifest. The segments can include only a portion of the entire content asset and can have a playback duration (e.g., less than 100 seconds, less than 60 seconds, less than 30 seconds, less than 10 seconds, etc.) that is less than the playback duration of the entire content asset.

In step 406, the first dynamic manifest can be transmitted, for example, to a source of the request for the first manifest. The first dynamic manifest may facilitate access to only a portion of a content asset. In an aspect, a user device and/or a media player can receive the first dynamic manifest and can request particular data segments to be received based at least on the received manifest. As an example, a first one of the manifests can relate to a first content segment of a content asset (e.g., content asset). When the media player reaches the end of the first one of the manifests, the media player can request and receive a second one of the manifests (as discussed in step 408) to continue the seamless playback of content such as the next segment of the content asset or an advertisement, etc.

In step 408, a request for a second manifest can be received or accessed by a computing device (e.g., the computing device 104) such as a manifest server, for example. The second manifest can comprise information relating to a location of one or more segments of a content asset such as an IP address, identifier of one or more content assets (e.g., advertisements, video on demand assets, recorded asset) browser or operating platform, device identifiers, browser cookies or login details, screen resolution of display, and other device, display, content, or user parameters. As an example, a user device and/or a media player executing on the user device can request the next manifest in a series of manifests relating to a particular content asset.

In step 410, one or more rules can be analyzed based at least on the request for the second manifest. In an aspect, the one or more rules relate to one or more of a trick play feature, a content permission, and a content insertion such as advertisement insertion. As an example, the user device (e.g., media player) can request additional manifests such that the content can be requested and playback of the content can continue in a seamless manner. As requests for new manifests (e.g., the second manifest) are received at the computing device, the computing device can analyze pre-determined rules to determine what content to provide to the user device and/or whether to even allow access to the content.

The use of the dynamic manifest can shift playback state control from the media player to the upstream computing device (e.g., server). Instead of the media player having access to all of the segments of a particular content asset, each dynamic manifest provides information relating to only a portion (e.g., n seconds of playback) of the overall content asset. As such, requests for trick play controls are routed to the server, which ensure policy enforcement by the content provider rather than the media player. As another example, advertisement insertion decisions can be made at the server and can be modified in real-time. As a further example, by moving control in to the server, the server can better know about and adapt to issues in the system and network architecture. If an advertisement server is unavailable, instead of relying on the user device to handle the outage, the server can manage the outage without disrupting playback via the media player.

In step 412, a second dynamic manifest can be generated. In an aspect, the second dynamic manifest can be generated in response to the request for the second manifest and/or the analyzed rules. The second dynamic manifest can be dynamic in the sense that it can be customized based on the request and/or information relating to a source for the request for the second manifest. The second dynamic manifest can comprise information relating to a location of one or more segments of a content asset. The segments can include only a portion of the entire content asset and can have a playback duration (e.g., less than 100 seconds, less than 60 seconds, less than 30 seconds, less than 10 seconds, etc.) that is less than the playback duration of the entire content asset.

In step 414, the second dynamic manifest can be transmitted, for example, to a source of the request for the second manifest. The second dynamic manifest may facilitate access to only a portion of a content asset. In an aspect, a user device and/or a media player can receive the second dynamic manifest and can request particular data segments to be received based at least on the received manifest. As an example, a second one of the manifests can relate to a second content segment of a content asset (e.g., content asset). When the media player reaches the end of the second one of the manifests, the media player can request and receive a third one of the manifests to continue the seamless playback of content such as the next segment of the content asset or an advertisement, etc.

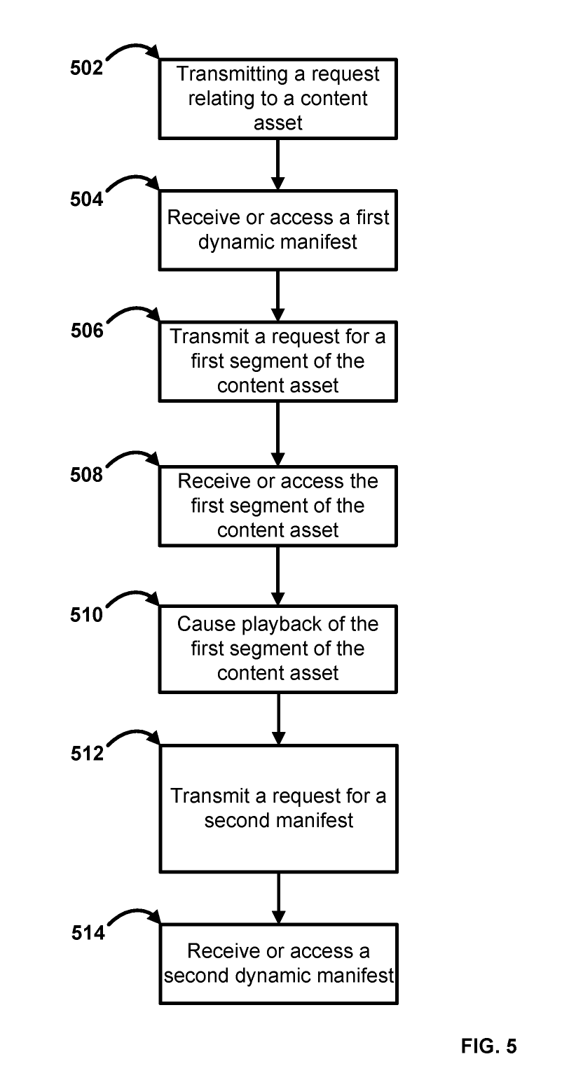

FIG. 5 illustrates an example method for managing playback of content. In step 502, a request relating to a content asset can be transmitted by a user device (e.g., the user device 102, the medial player 112, etc.), for example. The request can comprise tuning to a linear content channel or other linear source. The request can relate to a request for a non-linear content asset.

In step 504, a first dynamic manifest can be received or accessed. In an aspect, the first dynamic manifest can be received or accessed in response to the request of step 502. The first dynamic manifest can be dynamic in the sense that it can be customized based on the request and/or information relating to a source for the request for the first manifest. The first dynamic manifest can comprise information relating to a location of one or more segments of a content asset. The segments can include only a portion of the entire content asset and can have a playback duration (e.g., less than 100 seconds, less than 60 seconds, less than 30 seconds, less than 10 seconds, etc.) that is less than the playback duration of the entire content asset.

In an aspect, the first dynamic manifest may facilitate access to only a portion of a content asset. In an aspect, a user device and/or a media player can receive the first dynamic manifest and can request particular data segments, such as a first segment of the content asset, to be received based at least on the received manifest, at step 506. At step 508, the user device can receive the requested data segment. At step 510, the user device can cause playback of the received data segment such as the first segment of the content asset. As such, a user of the user device can view content based on the dynamic manifest, while having a linear content viewing experience. For example, a user may tune to a linear content channel. However, instead of or in addition to receiving linear content, a dynamic manifest may be provided to direct the user device to request segments of a non-linear content. In this way, the dynamic manifest can control the rendering of non-linear content in a dynamic fashion in order to emulate linear content. Other implementations of linear and non-linear content may be used based on a dynamic manifest.

In step 512, a request for a second manifest can be transmitted by a user device (e.g., the user device 102, the medial player 112, etc.), for example. The second manifest can comprise information relating to a location of one or more segments of a content asset such as an IP address, identifier of one or more content assets (e.g., advertisements, video on demand assets, recorded asset) browser or operating platform, device identifiers, browser cookies or login details, screen resolution of display, and other device, display, content, or user parameters. As an example, a user device and/or a media player executing on the user device can comprise a web browser (e.g., HLS enabled web browser). A user can use the media player to navigate to a website presenting a list of available content. After the user selects the content for playback, a request for the first manifest, such as a HTTP GET or POST request or other transfer mechanism, may be sent over a network to the computing device.

In step 514, a second dynamic manifest can be received or accessed. In an aspect, the second dynamic manifest can be received or accessed in response to the request for the second manifest. The second dynamic manifest can be dynamic in the sense that it can be customized based on the request and/or information relating to a source for the request for the first manifest. The second dynamic manifest can comprise information relating to a location of one or more segments of a content asset. The segments can include only a portion of the entire content asset and can have a playback duration (e.g., less than 100 seconds, less than 60 seconds, less than 30 seconds, less than 10 seconds, etc.) that is less than the playback duration of the entire content asset.

The use of the dynamic manifest can shift playback state control from the media player to the upstream computing device (e.g., server). Instead of the media player having access to all of the segments of a particular content asset, each dynamic manifest provides information relating to only a portion (e.g., n seconds of playback) of the overall content asset. As such, requests for trick play controls are routed to the server, which ensure policy enforcement by the content provider rather than the media player. As another example, advertisement insertion decisions can be made at the server and can be modified in real-time. As a further example, by moving control in to the server, the server can better know about and adapt to issues in the system and network architecture. If an advertisement server is unavailable, instead of relying on the user device to handle the outage, the server can manage the outage without disrupting playback via the media player.

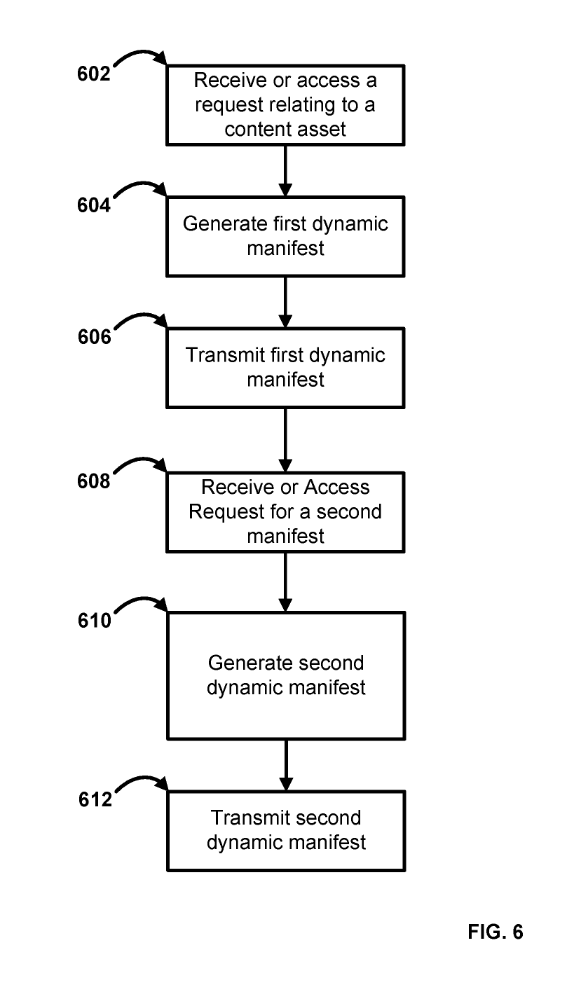

FIG. 6 illustrates an example method for managing playback of content. In step 602, a request relating to a content asset (e.g., tuning to a linear content channel) can be received or accessed by a computing device (e.g., the computing device 104). A user can use the media player to navigate to a website presenting a list of available content channels. After the user selects the content for playback, a request for the channel may be processed by a computing device, which may serve up non-linear content instead of linear content. The description of FIG. 6 is not intended to be limited to the implementation illustrated. In certain aspects, the request for content may relate to either linear or non-linear content and the content that is provided to the requestor may be linear or non-linear.

In step 604, a first dynamic manifest can be generated. In an aspect, the first dynamic manifest can be generated in response to the request of step 602. The first dynamic manifest can be dynamic in the sense that it can be customized based on the request and/or information relating to a source for the request for the first manifest. The first dynamic manifest can comprise information relating to a location of one or more segments of a content asset. The segments can include only a portion of the entire content asset and can have a playback duration (e.g., less than 100 seconds, less than 60 seconds, less than 30 seconds, less than 10 seconds, etc.) that is less than the playback duration of the entire content asset.

In step 606, the first dynamic manifest can be transmitted, for example, to a source of the request for the first manifest. The first dynamic manifest may facilitate access to only a portion of a content asset. In an aspect, a user device and/or a media player can receive the first dynamic manifest and can request particular data segments to be received based at least on the received manifest. As an example, a first one of the manifests can relate to a first content segment of a content asset. If the media player reaches the end of the first one of the manifests, the media player can request and receive a second one of the manifests (as discussed in step 408) to continue the seamless playback of content such as the next segment of the content asset or an advertisement, etc.

In step 608, a request for a second manifest can be received or accessed by a computing device (e.g., the computing device 104) such as a manifest server, for example. The second manifest can comprise information relating to a location of one or more segments of a content asset such as an IP address, identifier of one or more content assets (e.g., advertisements, video on demand assets, recorded asset) browser or operating platform, device identifiers, browser cookies or login details, screen resolution of display, and other device, display, content, or user parameters. As an example, a user device and/or a media player executing on the user device can request the next manifest in a series of manifests relating to a particular content asset.

In step 610, a second dynamic manifest can be generated. In an aspect, the second dynamic manifest can be generated in response to the request for the second manifest. The second dynamic manifest can be dynamic in the sense that it can be customized based on the request and/or information relating to a source for the request for the second manifest. The second dynamic manifest can comprise information relating to a location of one or more segments of a content asset. The segments can include only a portion of the entire content asset and can have a playback duration (e.g., less than 100 seconds, less than 60 seconds, less than 30 seconds, less than 10 seconds, etc.) that is less than the playback duration of the entire content asset.

In step 612, the second dynamic manifest can be transmitted, for example, to a source of the request for the second manifest. The second dynamic manifest may facilitate access to only a portion of a content asset. In an aspect, a user device and/or a media player can receive the second dynamic manifest and can request particular data segments to be received based at least on the received manifest. As an example, a second one of the manifests can relate to a second content segment of a content asset (e.g., content asset). When the media player reaches the end of the second one of the manifests, the media player can request and receive a third one of the manifests to continue the seamless playback of content such as the next segment of the content asset or an advertisement, etc.

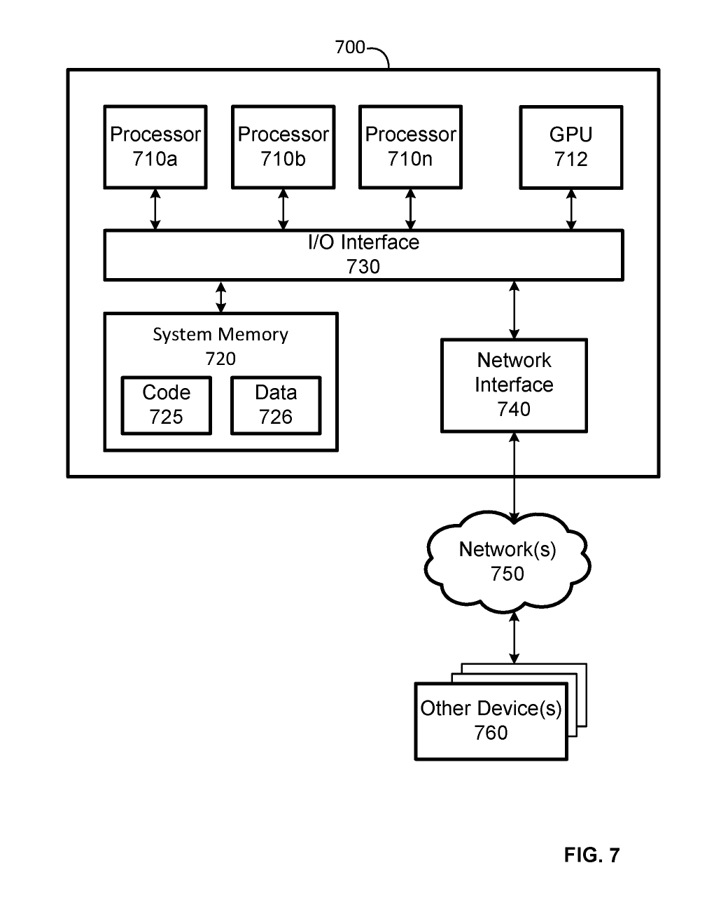

FIG. 7 depicts a general-purpose computer system that includes or is configured to access one or more computer-accessible media. In the illustrated embodiment, a computing device 700 may include one or more processors 710a, 710b, and/or 710n (which may be referred herein singularly as the processor 710 or in the plural as the processors 710) coupled to a system memory 720 via an input/output (I/O) interface 730. The computing device 700 may further include a network interface 740 coupled to an I/O interface 730.

In various embodiments, the computing device 700 may be a uniprocessor system including one processor 710 or a multiprocessor system including several processors 710 (e.g., two, four, eight, or another suitable number). The processors 710 may be any suitable processors capable of executing instructions. For example, in various embodiments, the processor(s) 710 may be general-purpose or embedded processors implementing any of a variety of instruction set architectures (ISAs), such as the x86, PowerPC, SPARC, or MIPS ISAs, or any other suitable ISA. In multiprocessor systems, each of the processors 710 may commonly, but not necessarily, implement the same ISA.

In some embodiments, a graphics processing unit (“GPU”) 712 may participate in providing graphics rendering and/or physics processing capabilities. A GPU may, for example, comprise a highly parallelized processor architecture specialized for graphical computations. In some embodiments, the processors 710 and the GPU 712 may be implemented as one or more of the same type of device.

The system memory 720 may be configured to store instructions and data accessible by the processor(s) 710. In various embodiments, the system memory 720 may be implemented using any suitable memory technology, such as static random access memory (“SRAM”), synchronous dynamic RAM (“SDRAM”), nonvolatile/Flash®-type memory, or any other type of memory. In the illustrated embodiment, program instructions and data implementing one or more desired functions, such as those methods, techniques and data described above, are shown stored within the system memory 720 as code 725 and data 726.

In one embodiment, the I/O interface 730 may be configured to coordinate I/O traffic between the processor(s) 710, the system memory 720 and any peripherals in the device, including an network interface 740 or other peripheral interfaces. In some embodiments, the I/O interface 730 may perform any necessary protocol, timing or other data transformations to convert data signals from one component (e.g., the system memory 720) into a format suitable for use by another component (e.g., the processor 710). In some embodiments, the I/O interface 730 may include support for devices attached through various types of peripheral buses, such as a variant of the Peripheral Component Interconnect (PCI) bus standard or the Universal Serial Bus (USB) standard, for example. In some embodiments, the function of the I/O interface 730 may be split into two or more separate components, such as a north bridge and a south bridge, for example. Also, in some embodiments some or all of the functionality of the I/O interface 730, such as an interface to the system memory 720, may be incorporated directly into the processor 710.

The network interface 740 may be configured to allow data to be exchanged between the computing device 700 and other device or devices 760 attached to a network or networks 750, such as other computer systems or devices, for example. In various embodiments, the network interface 740 may support communication via any suitable wired or wireless general data networks, such as types of Ethernet networks, for example. Additionally, the network interface 740 may support communication via telecommunications/telephony networks, such as analog voice networks or digital fiber communications networks, via storage area networks, such as Fibre Channel SANs (storage area networks), or via any other suitable type of network and/or protocol.

In some embodiments, the system memory 720 may be one embodiment of a computer-accessible medium configured to store program instructions and data as described above for implementing embodiments of the corresponding methods and apparatus. However, in other embodiments, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 700 via the I/O interface 730. A non-transitory computer-accessible storage medium may also include any volatile or non-volatile media, such as RAM (e.g., SDRAM, DDR SDRAM, RDRAM, SRAM, etc.), ROM, etc., that may be included in some embodiments of the computing device 700 as the system memory 720 or another type of memory. Further, a computer-accessible medium may include transmission media or signals, such as electrical, electromagnetic or digital signals, conveyed via a communication medium, such as a network and/or a wireless link, such as those that may be implemented via the network interface 740. Portions or all of multiple computing devices, such as those illustrated in FIG. 7, may be used to implement the described functionality in various embodiments; for example, software components running on a variety of different devices and servers may collaborate to provide the functionality. In some embodiments, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the present disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

The methods and systems can employ artificial intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It is to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and comprise the disclosed systems. These and other components are disclosed herein, and it is understood that when combinations, subsets, interactions, groups, etc. of these components are disclosed that while specific reference of each various individual and collective combination and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, by a processor, a request for linear content;
generating, by the processor and in response to the request for linear content, a first dynamic manifest indicating a location of a first portion of a non-linear content asset;
transmitting the first dynamic manifest to a source of the request, wherein the first dynamic manifest facilitates access to the first portion of the non-linear content asset;
receiving, by the processor, a request for a second manifest;
analyzing one or more rules based at least on the request for the second manifest;
generating, in response to at least the request for the second manifest and the one or more rules, a second dynamic manifest indicating a location of a second portion of the non-linear content asset; and
transmitting the second dynamic manifest to a source of the request.

2. (canceled)

3. The method of claim 1, wherein the non-linear content asset comprises a video on demand asset or a network recorder asset.

4. The method of claim 1, wherein a playback duration of the first portion is less than 100 seconds.

5. The method of claim 1, wherein the one or more rules are associated with a trick play feature, a content permission, or a content insertion, or a combination thereof.

6. The method of claim 1, wherein the one or more rules are associated with an advertisement insertion, a blackout event, or a content feature, or a combination thereof.

7. The method of claim 1, wherein the request for the second manifest comprises information associated with a user and the one or more rules relate to a content permission associated with the user.

8. A method comprising:
transmitting, by a processor, a request relating to a linear content asset;
receiving, in response to the request relating to the linear content asset, a first dynamic manifest relating to a first segment of a non-linear content asset, wherein the first segment has a playback duration that is less than the playback duration of the entire non-linear content asset;
transmitting, by the processor, a request for the first segment of the non-linear content asset based at least on the first dynamic manifest; and
transmitting a request for a second manifest.

9. The method of claim 8, wherein the request for the linear content asset comprises tuning to a linear content channel.

10. The method of claim 8, wherein the non-linear content asset comprises a video on demand asset or a network recorder asset.

11. The method of claim 8, wherein the playback duration of the first segment is less than 100 seconds.

12. The method of claim 8, further comprising:
receiving, in response to the request for the second manifest, a second dynamic manifest relating to a second segment of the non-linear content asset, wherein the second segment has a playback duration that is less than the playback duration of the entire non-linear content asset.

13. The method of claim 12, wherein the playback duration of the second segment is less than 100 seconds.

14. The method of claim 8, further comprising receiving the first segment of the non-linear content asset and causing playback of the first segment of the non-linear content asset.

15. A method comprising:
receiving, by a processor, a request for linear content;
generating, in response to the request for linear content, a first dynamic manifest associated with a first segment of a non-linear content asset, wherein the first segment has a playback duration that is less than the playback duration of the entire non-linear content asset;
transmitting the first dynamic manifest to a source of the request, wherein the first dynamic manifest facilities access to the first segment of the non-linear content asset;
receiving, by the processor, a request for a second manifest;
generating, in response to at least the request for the second manifest, a second dynamic manifest associated with a second segment of the non-linear content asset; and
transmitting the second dynamic manifest to a source of the request.

16. (canceled)

17. The method of claim 15, wherein the non-linear content asset comprises a video on demand asset or a network recorder asset.

18. The method of claim 15, wherein the playback duration of the first segment is less than 100 seconds.

19. The method of claim 15, wherein the playback duration of the second segment is less than 100 seconds.

20. The method of claim 15, wherein the request for the second manifest comprises information associated with a user and one or more rules related to a content permission associated with the user.

21. The method of claim 1, wherein the request for linear content comprises tuning to a linear content channel.

22. The method of claim 15, wherein the request for linear content comprises tuning to a linear content channel.
